(19) United States
(12) Patent Application Publication
(10) Pub. No.: US 2014/0010550 A1
(43) Pub. Date: Jan. 9, 2014

(54) Method and Device for Providing Notifications in a System for Visible-Light communication

(71) Applicants: Michael Bahr, Munchen (DE); Joachim Walewski, Unterhaching (DE)

(72) Inventors: Michael Bahr, Munchen (DE); Joachim Walewski, Unterhaching (DE)

(21) Appl. No.: 14/004,874

(22) PCT Filed: Mar. 16, 2012
(86) PCT No.: PCT/EP2012/054671

§ 371 Date: Sep. 12, 2013

(30) Foreign Application Priority Data
Mar. 16, 2011 (EP) 11158494.2

(51) Int. Cl. H04B 10/116

(52) U.S. Cl. CPC H04B 10/116
USPC 398/127

(57) ABSTRACT

A method for providing visible notification by a device in a visible-light-communication system based on Institute of Electrical and Electronic Engineers (IEEE) standard 802.15.7, wherein higher levels are allowed to invoke through one standardized interface a medium-access-control sub-layer to provide color-function support and enables invocation of a transmission of color, visibility, and dimming frames by a higher layer, which creates a unified interface between the MAC sub-layer and the higher layers, while providing a primitive for requesting, by the at least one upper layer to the at least one interface of the medium-access-control entity layer, a transmission of at least one visibility frame.

### CROSS-REFERENCE TO RELATED APPLICATIONS

This is a U.S. national stage of application No. PCT/EP2012/054671 filed 16 Mar. 2012. Priority is claimed on European Application No. 11158494 filed 16 Mar. 2011, the content of which is incorporated herein by reference in its entirety.

### BACKGROUND OF THE INVENTION

1. Field of the Invention

The invention relates to a method and device for communicating by a visible-light transmission of data and, more particularly, to a method and device for providing visible notifications in a system for visible-light communication based on the specifications of Institute of Electrical and Electronic Engineers (IEEE) standard 802.15.7.

2. Description of the Related Art

In the field of indoor wireless networks, visible-light communications (VLC) is garnering increasing attention. One type of emitter used in this technology is a light-emitting diode, which can synergistically provide both illumination and data transmission.

One possible transmission mode for VLC is known as color-shift keying (CSK). CSK supports visible-light communications using multi-color light sources and photodetectors. CSK is a modulation scheme for visible-light communication involving multiple light sources. CSK keeps the average emitted optical color and the total optical power constant during communication by taking advantage of the persistence of the human eye. According to a draft D6 of IEEE standard 802.15.7, a CSK signal is generated by using three color light sources. Hereinafter, the draft D6 of IEEE standard 802.15.7 is simply referred to as [symbol] draft standard [symbol] .

In CSK, the transmission of data is provided by applying a modulation of the three colors that is not detectable by a human eye in normal operation modes, because the persistence of vision of a human eye is not able to follow the modulation frequency. There are scenarios, however, in which a visible modulation of the colors is desirable in contrast to synergistically provided illumination by a VLC system. These scenarios are reflected in chapter 5.1.12 of the draft standard.

According to the draft standard, a color-function support is defined, in which various colors can be used to indicate various statuses of a device to a human recipient, such as the human user of a VLC transceiver. Such an indication is also referred to as color notification.

Alternatively, or as a complement, notifications are indicated by an intermittence of the illumination. This kind of notification is also referred to as a blinking notification that is reflected by chapter 5.3.9 of the draft standard.

The color-function support aims at an intuitive visualization of state changes of devices involved in the visible light communication to a user, such as for indicating connected devices, a good link, a broken link or a status in which a file transfer is almost completed.

For a specific notification, a specific color or, alternatively, a variety of at least two alternating colors of light, emitted by the optical source, can be used. According to the draft standard, the colors chosen for different statuses are left to the discretion of an implementer.

Currently, the color-function support defined by the draft standard is solely implemented in a medium-access control (MAC) sub-layer of the protocol used in visible-light communications.

The color function is requested by a color visibility dimming (CVD) frame issued within the MAC sub-layer. Such color visibility dimming frames are generally used for color, visibility and dimming support. The payload of the frame consists of visibility patterns of appropriate intensity and color.

Due to the implementation in the MAC sub-layer, which is relatively close to the physical or hardware layer, it is currently not possible for higher levels, i.e., the application level, to directly invoke color-function support. This drawback, however, inadequately limits the essence of such notification, because it is rather in the discretion of an application layer to handle a notification than the MAC sub-layer. Within the MAC sub-layer, in turn, the scope of instructions is limited to a hardware-based view.

### SUMMARY OF THE INVENTION

It is therefore an object of the present invention to provide a method and device for allowing higher levels to invoke one standardized interface to the MAC sub-layer for the purpose of color-function support.

It is a further object of the present invention to enable invocation of a transmission of CVD frames by the higher layer and to create a unified interface between the MAC sub-layer and the higher layer.

According to a preferred embodiment of the invention, a method for enabling a visible notification by a device in a system for visible-light communication is provided, where the communication system is based on the specifications of IEEE standard 802.15.7.

The device includes a medium-access-control entity (MAC) interfaced between a physical layer (PHY) and at least one upper layer, where the at least one upper layer is hierarchically arranged above the medium-access-control entity (MAC). The medium-access-control entity (MAC) includes at least one interface (MLME-SAP, MCPS-SAP) to the upper layer, where the method includes the step providing a primitive for requesting, by the at least one upper layer to the at least one interface MAC Common Part Sublayer-Service Access Point (MLME-SAP) or MAC Layer Management Entity-Service Access Point (MCPS-SAP) of the medium-access-control entity (MAC), a transmission of at least one visibility frame.

In accordance with the invention, a primitive is provided for requesting a transmission of CVD frames by a higher layer, e.g., through an MLME interface.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The objects as well as further advantages of the present invention will become more apparent and readily appreciated from the following description of the preferred embodiments, taken in conjunction with the accompanying drawing, in which:

FIG. 1 depicts a timing diagram showing the exchange of messages between different layers of a device and a coordinator in a visible-light communication system, where the messages support a color-function notification for an association in accordance with an embodiment of the invention;

FIG. 2 depicts a timing diagram showing the exchange of messages between different layers of an originator and a recipient in a visible-light communication system, where the messages support an acknowledgement indication accompanying a data transfer in accordance with an alternative embodiment of the invention;

FIG. 3 depicts a timing diagram showing the exchange of messages between different layers of a recipient and an originator in a visible-light communication system, where the messages support a channel-quality indication in accordance with an alternative embodiment of the invention;

FIG. 4 depicts a timing diagram showing the exchange of messages between different layers of a recipient and an originator in a visible-light communication system, where the messages support an indication of a file-transfer status in accordance with an alternative embodiment of the invention;

FIG. 5 depicts an architecture of a device in a visible-light communication system in accordance with the prior art;

FIG. 6 depicts a timing diagram showing the exchange of messages between MAC sub-layers of a device and a coordinator in a visible-light communication system, where the messages support an association in accordance with the prior art;

FIG. 7 depicts a timing diagram showing the exchange of messages between MAC sub-layers of a device and a coordinator in a visible-light communication system, where the messages support an acknowledgment indication in accordance with the prior;

FIG. 8 depicts a timing diagram showing the exchange of messages between MAC sub-layers of an originator and a recipient in a visible-light communication system, where the messages support a file transfer status indication in accordance with the prior art; and

FIG. 9 is a flowchart of the method in accordance with an embodiment of the invention.

### DETAILED DESCRIPTION OF THE PREFERRED EMBODIMENTS

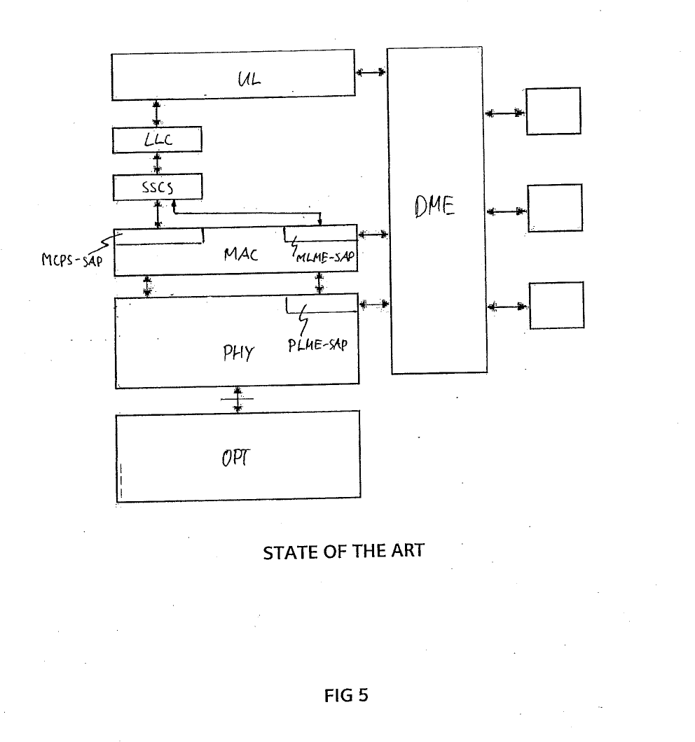

Referring to FIG. 5, an architecture of a device in a visible-light communication system in accordance with the prior art is illustrated.

The architecture of a visible-light communication system is generally defined in terms of a number of layers and sub-layers. Each layer is responsible for one part of the draft standard and offers services to the higher layers. The interface between the layers serves to define the logical links that are described in the draft standard.

More specifically, FIG. 5 shows an architecture of a visible-light communication personal area network (VPAN) device according to chapter 4.4 of the draft standard.

A VPAN device comprises a physical layer PHY, which contains a light transceiver along with its low-level control mechanism which are generally directed to an optical layer OPT including the actual optical devices, including light emitting diodes and/or photodetectors.

Furthermore, a medium-access control layer MAC provides access to a physical layer PHY for all types of transfers. FIG. 5 shows these layers in a graphical representation, which are described in more detail in chapters 4.4.1 and 4.4.2 of the draft standard.

The upper layers UL, shown in FIG. 5, consist of a network layer (not shown), which provides network configuration, manipulation, a messaged routing entity (not shown) and an application layer (not shown), which provides the intended function of the device.

A logical link control layer LLC accesses the medium-access control layer MAC through the service-specific convergence sub-layer SSCS. Both, logical link control layer LLC and service-specific convergence sub-layer SSCS are hereinafter assumed to be likewise included in the upper layer.

Interfaces, also referred to as SAP or [symbol] service access points [symbol] by the draft standard, are used to access certain attributes from another layer. The medium-access control layer MAC provides two service access points.

MAC data is accessed by a first access point MCPS-SAP ( [symbol] MAC common part sub-layer SAP [symbol] ) while MAC management is accessed by a second access point MLME-SAP ( [symbol] MAC sub-layer management entity SAP [symbol] ). Both access points are regarded as an interface to an upper layer in the generality of the foregoing.

A device-management entity DME is supported in the architecture. The DME interfaces the MAC. The physical layer PHY is interfaces with the MAC. The DME can access the PHY through the MAC sub-layer for the purpose of, e.g., dimming an illumination of the visible-light communication system. In FIG. 5, three boxes without reference signs on the right side of the device-management entity DME are characterizing the multi-purpose interfacing of the device-management entity DME by various applications including, but not limited to an entity for dimming the illumination of the visible-light communication system.

The device-management entity DME is hereinafter assumed to be likewise included in the upper layer.

The DME can access certain attributes from respective service access points. These service access points include the access point MLME-SAP mentioned above and a PLME-SAP ( [symbol] physical-layer management entity [symbol] ) for interfacing the physical layer PHY. The MLME-SAP is currently used to provide dimming information from the device-management entity DME to the medium-access control layer MAC. The device-management entity DME can also control the physical layer PHY by the service access point PLME-SAP for a selection of optical sources and photodetectors. The device-management entity DME is not the only entity that is able to access the access point MLME-SAP. Referring to FIG. 5, any higher layer, including the service-specific convergence sub-layer SSCS, can access the access point MLME-SAP.

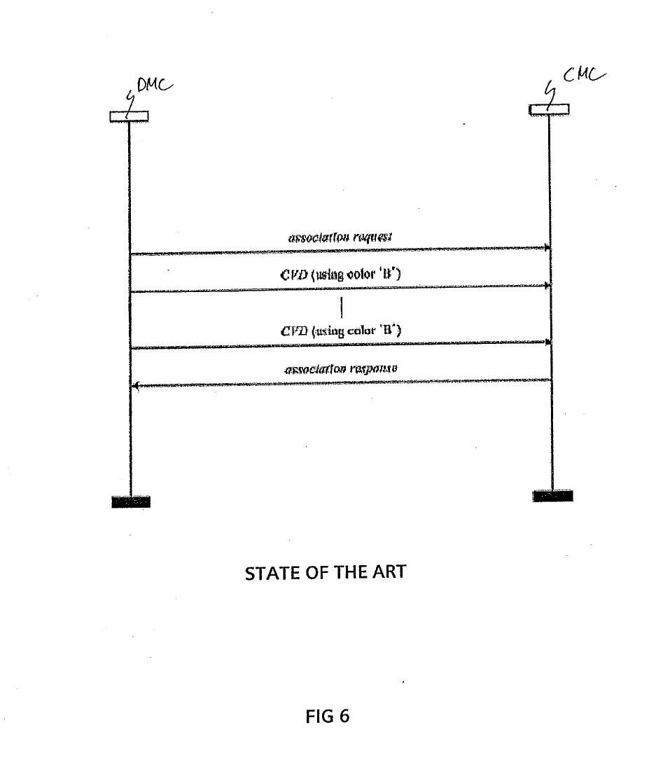

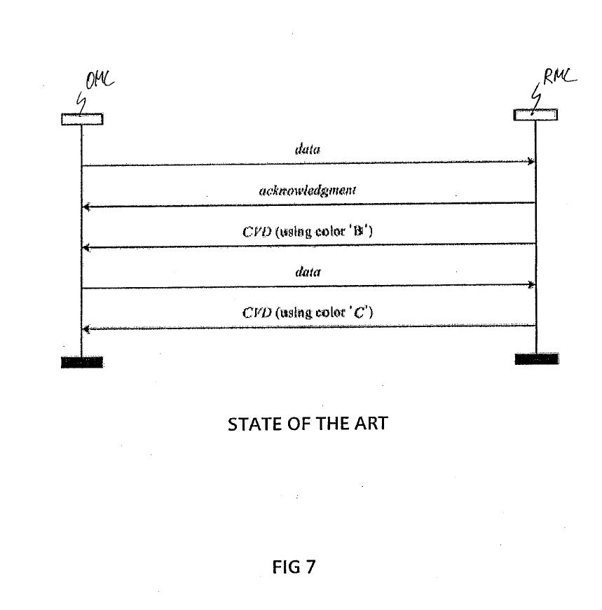

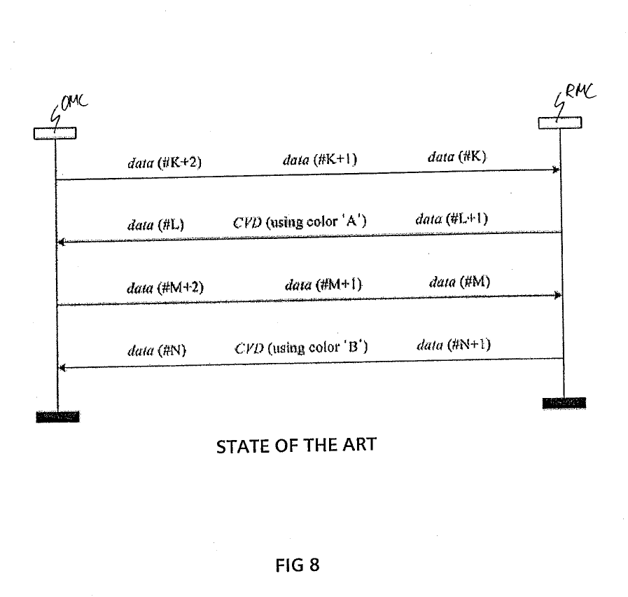

In the following section, three conventional use cases are described in FIG. 6, FIG. 7, and FIG. 8.

FIG. 6 depicts a timing diagram showing the exchange of messages between MAC sub-layers of a device and a coordinator in a visible-light communication system, where the messages support a visual notification of an association in accordance with the prior art. FIG. 6 shown here is substantially identical to FIG. 35 shown in chapter 5.1.12.1 of the draft standard.

Specifically, FIG. 6 shows an exchange of messages between a MAC sub-layer entity DMC of the device and a MAC sub-layer entity CMC of the coordinator. The exchange of messages serves to associate the device with a designated coordinator, whereby the association is to be notified by a color-function support using CVD frames in accordance with the draft standard. The CVD frames are used between state changes to provide visual information to the user regarding the communication status, here an association of the device to the coordinator.

At the beginning, the MAC sub-layer entity DMC of the device sends a message captioned [symbol] association request [symbol] to the MAC sub-layer entity CMC of the coordinator. This association request is communicated using the MLME-ASSOCIATE.request primitive as described in chapter 6.3.1.1 of the draft standard. The process of association is generally described in chapter 5.1.4.1 of the draft standard.

In order to notify the user, a frame captioned [symbol] CVD (using color ‘B’) [symbol] is sent by the MAC sub-layer entity DMC of the device to the MAC sub-layer entity CMC of the coordinator using a chosen color, which is exemplarily set to [symbol] color ‘B’ [symbol] .

The frame captioned [symbol] CVD (using color ‘B’) [symbol] is a color visibility dimming (CVD) frame serving the purpose of visual notification.

As shown, the frame can be sent repeatedly in order to repeat the visual notification.

Finally, after the association is completed, the MAC sub-layer entity CMC of the coordinator sends a message captioned [symbol] association response [symbol] to the MAC sub-layer entity DMC of the device to inform the device of a successful or failed association.

In FIG. 7, an exchange of messages between a MAC sub-layer entity OMC of an originator and a MAC sub-layer entity RMC of a recipient is depicted, where the messages support an acknowledgement indication accompanying a data transfer according to the prior art as described in the draft standard.

The procedure starts by sending a data message, which is sent by the originator's MAC sub-layer entity OMC.

The successful reception of the data frame is communicated by the recipient's MAC sub-layer entity RMC to the originator's MAC sub-layer entity OMC by sending a message captioned [symbol] acknowledgement [symbol] .

In order to notify this successful data transfer, the recipient's MAC sub-layer entity RMC sends a corresponding frame captioned [symbol] CVD frame (using color ‘B’) [symbol] to the MAC sub-layer entity OMC of the originator. Said frame captioned [symbol] CVD (using color ‘B’) [symbol] is a color visibility dimming (CVD) frame serving the purpose of visual notification.

In the lower half of FIG. 7, a similar message exchange is depicted with the difference that the acknowledgment is not arriving which is leading to the assumption of the originator that the data transfer was not successfully completed and that the transfer is to be indicated by a visible color C, such as red.

In order to notify this data transfer failure, the recipient's MAC sub-layer entity RMC sends a corresponding frame captioned [symbol] CVD frame (using color ‘C’) [symbol] to the MAC sub-layer entity OMC of the originator. Said frame captioned [symbol] CVD (using color ‘C’) [symbol] is a color visibility dimming (CVD) frame serving the purpose of visual notification.

In FIG. 8, an exchange of messages between a MAC sub-layer entity OMC of an originator and a MAC sub-layer entity RMC of a recipient is depicted, where the messages support a file-transfer status indication accompanying a data transfer according to the state of the art, as described in chapter 5.1.12.4 of the draft standard.

The purpose of a color-supported notification is to allow a user to infer the remaining or transferred file size through the color of the CVD frame.

As shown in the example of FIG. 8, the originator transfers data frames to the device, which are numbered by a certain value K, M, N according to a respective data size measured in bytes. Different stages of the file transfer process can be represented with different choices of colors. For example, in order to use this indication the recipient needs to know the total file size to be transmitted.

The remaining file size can be obtained by subtracting the transferred file size from the total file size. A MAC PIB attribute is used for the color assignment of the CVD frame when the CVD frame is sent to indicate the application-dependent information, such as the file-transfer status.

The procedure starts by sending data frames captioned [symbol] data (#K+2) [symbol] , [symbol] data (#K+1) [symbol] , [symbol] data (#K) [symbol] from the originator's MAC sub-layer entity OMC to the recipient's MAC sub-layer entity RMC.

As long as the remaining or transferred file size is above a value of L bytes, the recipient's MAC sub-layer entity RMC sends a frame captioned [symbol] CVD (using color ‘A’) [symbol] to the MAC sub-layer entity OMC of the originator. The frame captioned [symbol] CVD (using color ‘A’) [symbol] is a color visibility dimming (CVD) frame serving the purpose of visual notification. For instance, a color A such as orange can be displayed to the user, indicating that a current data transfer will be still consuming a considerable amount of time to be completed.

After the transmitted data frames have reached a limit of M by sending data frames captioned [symbol] data (#M+2) [symbol] , [symbol] data (#M+1) [symbol] , [symbol] data (#M) [symbol] , which, in turn leads to a remaining file size of less than N bytes, the recipient's MAC sub-layer entity RMC sends a frame captioned [symbol] CVD frame (using color ‘B’) [symbol] to the MAC sub-layer entity OMC of the originator. For instance, a color B such as yellow can be displayed to the user, indicating that a current data transfer will be soon completed.

Hereinafter, an exemplary implementation in accordance with an embodiment of the invention is described as follows. In accordance with the invention, a primitive for requesting a transmission of at least one visibility frame is to be implemented, whereby the request is directed form the upper layer to the interface of the medium-access-control entity. For interfacing either the medium-access-control link-management entity service access point (MLME-SAP) or the medium-access-control common-part sub-layer service access point (MCPS-SAP) according to the system architecture of the draft standard shown in FIG. 5 can be chosen. Choosing the first mentioned interface medium-access-control link-management entity service access point (MLME-SAP) has some advantages over the latter mentioned interface, which will be explained subsequently in the description. Therefore, the implementation according to this embodiment will be described with respect to the interface MLME-SAP, without limiting the generality of the invention.

An exemplary primitive for requesting a transmission of at least one visibility frame, or CVD frame, according to this embodiment is defined as a message MLME-CF.send ( . . . ). This message includes three parameters, i.e., CVDRepetitions, CVDColor, CVDDuration and CVDCycleLength. The message MLME-CF.send (CVDRepetitions, CVDColor, CVDDuration, CVDCycleLength) is issued by an upper layer to the medium-access-control entity.

If the arguments of the message MLME-CF.send( ) are empty or not present, default and/or current settings of attributes are used within the MAC sub-layer. The attributes are also referred to as PIB attributes (physical-layer personal-area-network information base) according to the draft standard.

Default PIB attributes can be inquired with a message MLME-GET and can be changed with a message MLME-SET. The messages are known primitives for reading PIB attributes, which are described in the draft standard in chapter 6.3.4 and 6.3.10, accordingly.

It should be understood that the caption of messages, parameters, attributes etc. used in this description is not decisive. In other words, the implementation of this embodiment can be realized with any other alternative captions.

The parameters of this message are explained below.

The [symbol] CVDRepetitions [symbol] parameter states the number of times a CVD frame is repeatedly sent. Its data type is an integer having a valid rage from zero to 255.

The [symbol] CVDColor [symbol] parameter defines a color of the CVD frame during a pertinent repetition. Its data type is a column vector of n₁ integers. The values of each respective element of the column vector can range from 0 to 255. Each element is a pointer to the look-up table captioned [symbol] phyColorFunction [symbol] . The look-up table is organized in three columns per row, whereby a first row is an index, a second and a third column define the color. The [symbol] phyColorFunction [symbol] look-up table is defined in table 99 of the draft standard.

The [symbol] CVDDuration [symbol] parameter is a column vector of n₂ integers. The values of each respective element of the column vector can range from 1 to 10,000. Each respective element of the column vector defines the duration of the CVD frame in increments of 10 ms during a pertinent repetition.

The [symbol] CVDCycleLength [symbol] parameter is a column vector of n₃ integers. The values of each respective element of the column vector can range from 1 to 65,536. Each respective element of the column vector defines the time between a beginning of a transmission of two adjacent CVD frames during the pertinent repetition by an incremental factor of 10 ms.

An exemplary primitive for confirming a transmission of at least one visibility frame, or CVD frame, according to this embodiment is defined as a message MLME-CF.confirm ( . . . ). This message includes one parameter, i.e., Status. The message MLME-CF.send (Status) is issued by the medium-access-control entity to the upper layer after an execution of an action instructed by the message MLME-CF.send ( . . . ). It is sent by the medium-access-control entity to the upper layer.

The [symbol] Status [symbol] parameter defines the status of attempting to invoke color-function support. Its data type is an enumeratio consisting of the fields TRANSMISSION_SUCCESS, FAILURE, CVD_FRAME_NOT_SUPPORTED, CURRENTLY_NOT_POSSIBLE and INVALID_PARAMETERS.

Hereinafter, MAC-PIB attributes (physical-layer personal-area-network information base) are defined. These attributes are used within the MAC sub-layer. Each attribute is providing data reflecting a setting, which was previously set by a message. The data will be saved until it is changed by another message.

The MAC-PIB attribute [symbol] macCVDRepetitions [symbol] defines the number of times CVD frames are sent. Its data type is an integer having a valid rage from zero to 255. The factory default for this MAC-PIB attribute can be optionally set to a value of zero.

The MAC-PIB attribute [symbol] CVDColor [symbol] defines a color of the CVD frame during a pertinent repetition. Its data type is a column vector of n₁ integers. The values of each respective element of the column vector can range from 0 to 255. Each element is a pointer to the look-up table captioned [symbol] phyColorFunction [symbol] , which is described above. The factory default for this MAC-PIB attribute can be optionally set to a vectorial value of zero.

The MAC-PIB attribute [symbol] macCVDDuration [symbol] is a column vector of n₂ integers. The values of each respective element of the column vector can range from 1 to 10,000. Each respective element of the column vector defines the duration of the CVD frame in increments of 10 ms during a pertinent repetition. The factory default for this MAC-PIB attribute can be optionally set to a vectorial value of 50.

The MAC-PIB attribute [symbol] macCVDCycleLength [symbol] is a column vector of n₃ integers. The values of each respective element of the column vector can range from 1 to 65,536. Each respective element of the column vector defines the time between a beginning of a transmission of two adjacent CVD frames during the pertinent repetition by an incremental factor of 10 ms. The factory default for this MAC-PIB attribute can be optionally set to a vectorial value of 100.

According to an alternative embodiment, an interface with less functionality may be defined. If, e.g., a default duty cycle (CVDDuration/CVDCycleLength=0.5) is chosen, either CVDCycleLength of CVDDuration can be discarded.

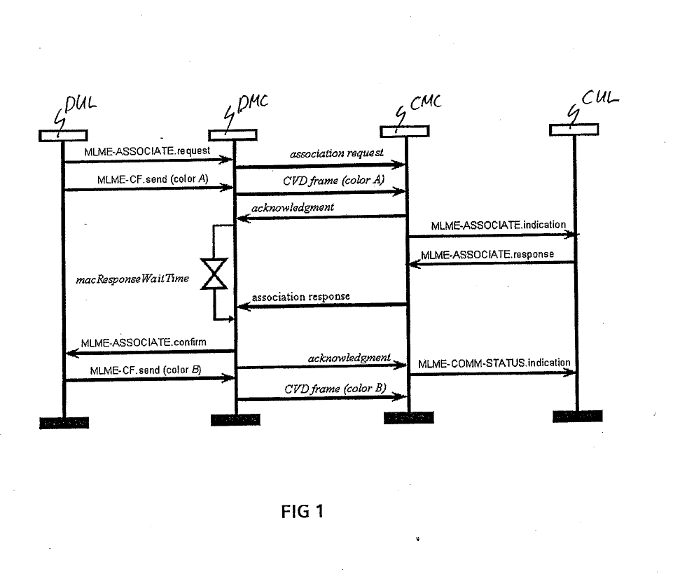

With reference to FIG. 1, shown therein is a timing diagram showing the exchange of messages between different layers of a device and a coordinator in a visible-light communication system, where the messages support a color-function notification for an association according to an embodiment of the invention.

In FIG. 1, an exchange of messages between an upper layer entity DUL of a device, a MAC sub-layer entity DMC of the device, a MAC sub-layer entity CMC of a coordinator and an upper layer entity CUL of the coordinator is depicted.

Generally, an upper layer entity is assumed to be an entity that is hierarchically and/or logically positioned in a layer above the MAC sub-layer. An upper layer entity includes an entity being part or assigned [symbol] upper layers [symbol] in the sense of the architectural description outlined above, including the link control layer LLC and/or service-specific convergence sub-layer SSCS and/or to the device-management entity DME along with the respective interfaces also referred to as service access points. Examples for an upper layer include an application such as a web browser, FTP (file transfer protocol) or a VoIP (voice over internet protocol) phone.

The device's MAC sub-layer entity DMC is interfaced by one of the MAC service access units MLME-SAP, MCPS-SAP (not shown in FIG. 1). Hereinafter it will be assumed that the medium-access-control link-management entity service access point MLME-SAP will be used in this embodiment without limiting the generality of the invention.

The procedure starts by sending a known MLME-ASSOCIATE.request message that is sent by an upper layer, here a device upper layer entity DUL to a device's MAC sub-layer entity DMC, the message being a primitive allowing the device to request an association with the coordinator. The MLME-ASSOCIATE.request message is described in chapter 6.3.1.1 of the draft standard.

On receipt of the MLME-ASSOCIATE.request primitive by the device's MAC sub-layer entity DMC, the device's MAC sub-layer entity DMC sends a message captioned [symbol] association request [symbol] to the MAC sub-layer entity CMC of the coordinator, as shown in FIG. 1.

In a next step, according to a preferred embodiment of the invention, a primitive for requesting a transmission of at least one visibility frame is transmitted. Specifically, a request message MLME-CF.send (color A), which is sent by the at least one upper layer, here a device's upper layer entity DUL to a device's MAC sub-layer entity DMC, the message MLME-CF.send (color A) requesting a transmission of at least one visibility frame having a color [symbol] A [symbol] .

For exemplary purposes, it is assumed that the argument [symbol] color A [symbol] of the message MLME-CF.send (color A) is specifically including the following parameters in its argument:

CVDRepetitions=1;

CVDColor=10;

CVDDuration=50; and;

CVDCycleLength=100.

Hence, the message MLME-CF.send (color A) is specifically of the form MLME-CF.send (1, 10, 50, 100).

The frame MLME-CF.send (color A) is used to effect a visual notification that an attempt to associate the device has been started. This may be exemplarily indicated by assigning a yellow color for color A.

After reception of the message MLME-CF.send (color A) by the device's MAC sub-layer entity DMC, the device's MAC sub-layer entity DMC sends a corresponding frame captioned [symbol] CVD frame (using color ‘A’) [symbol] to the MAC sub-layer entity CMC of the coordinator using a chosen color, which is exemplarily set to [symbol] color ‘A’ [symbol] . The frame captioned [symbol] CVD (using color ‘A’) [symbol] is a color visibility dimming (CVD) frame serving the purpose of visual notification.

The reception of the association request is confirmed by a message captioned [symbol] acknowledgement [symbol] that is sent from the coordinator's MAC sub-layer entity CMC to the device's MAC sub-layer entity DMC.

In a further step, the reception of an association request is indicated by the coordinator's MAC sub-layer entity CMC to the coordinator's upper layer entity CUL by sending a message entitled [symbol] MLME-ASSOCIATE.indication [symbol] according to chapter 6.3.1.2 of the draft standard.

Upon reception of the MLME-ASSOCIATE.indication primitive, the coordinator's upper layer entity CUL determines whether to accept or reject the still unassociated device. The coordinator's upper layer entity CUL then issues a message captioned [symbol] MLME-ASSOCIATE.response [symbol] according to chapter 6.3.1.3 of the draft standard to the coordinator's MAC sub-layer entity CMC.

Finally, after the association is completed, the MAC sub-layer entity CMC of the coordinator sends a message captioned [symbol] as-sociation response [symbol] to the MAC sub-layer entity DMC of the device to inform the device of a successful or failed association.

The association decision and the response have to become available at the device within a time captioned [symbol] macResponseWaitTime [symbol] . After this time, the device requesting association attempts to extract the association response command frame from the coordinator, in order to determine whether the association was successful.

After reception of the message captioned [symbol] association response [symbol] at the MAC sub-layer entity DMC of the device, a message captioned [symbol] MLME-ASSOCIATE.confirm [symbol] according to chapter 6.3.1.4 of the draft standard is sent to the device's upper layer entity DUL to inform the upper layer of the initiating device whether its request to associate was successful or not.

The successful reception of the message captioned [symbol] MLME-ASSOCIATE.confirm [symbol] is finally communicated by the device's MAC sub-layer entity DMC to the coordinator's MAC sub-layer entity CMC by sending a message captioned [symbol] acknowledgement [symbol] . Upon reception of the acknowledgement, the coordinator's MAC sub-layer entity CMC issues a message captioned [symbol] MLME-COMM-STATUS.indication [symbol] to the coordinator's upper layer entity CUL.

After reception of the message [symbol] MLME-ASSOCIATE.confirm [symbol] at the device's upper layer entity DUL, a visual notification of the association status is desirable and supported by this embodiment of the invention. The device's upper layer entity DUL issues a message MLME-CF.send (color B) to the device's MAC sub-layer entity DMC which sends a corresponding frame captioned [symbol] CVD frame (using color ‘B’) [symbol] to the MAC sub-layer entity CMC of the coordinator using a chosen color, which is exemplarily set to [symbol] color ‘B’ [symbol] . The message MLME-CF.send (color B) is used to effect a visual notification that the association of the device has been completed. This may be exemplarily indicated by a assigning a green color for color B.

In the following, the implications on the physical layer after the reception of the message MLME-CF.send (color A) are described. These implications are not shown in FIG. 1.

After the reception of the message MLME-CF.send (color A) at the device's MAC sub-layer entity DMC, the device's MAC sub-layer entity DMC invokes a message captioned [symbol] PD-DATA.request [symbol] (not shown) as specified in chapter 9.3.1 of the draft standard, where the PD-DATA includes parameters received by the MLME-CF.send (color A) request.

In the physical layer (not shown), a data packet of a color [symbol] 10 [symbol] according to the phyColorFunction table is composed, at least one data packet having a total duration of 50*10 ms. Instead of using a single packet, a sequence of a plurality of packets can be used. The total duration of the sequence has to be equal to the duration in a case using a single frame. The next transmission of a color-function color visibility dimming (CVD) frame is scheduled after a time period of 50 ms, according to the arguments calculated as (100*10−50*10). This data packet is [symbol] tunneled [symbol] through the physical layer PHY, and at least one optical transmitter is emitting the corresponding light with the color A.

After the physical layer PHY has reported a successful transmission to the device's MAC sub-layer entity DMC by aid of a PD-DATA primitive (not shown), the device's MAC sub-layer entity DMC in turn reports the successful execution with the MLME-CF primitive [symbol] MLME-CF.confirm [symbol] to the device upper layer entity DUL. For the sake of improved clarity, this message is not shown in FIG. 1.

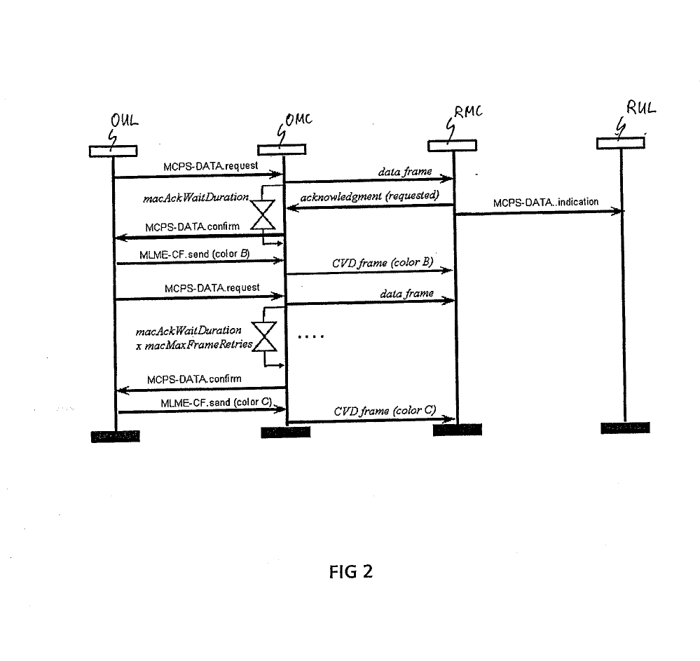

In FIG. 2, an exchange of messages between an upper layer entity OUL of an originator, a MAC sub-layer entity OMC of the originator, a MAC sub-layer entity RMC of a recipient and an upper layer entity RUL of the recipient is depicted.

Specifically, FIG. 2 depicts a timing diagram showing the exchange of messages between different layers of an originator and a recipient in a visible-light communication system, where the messages support an acknowledgement indication accompanying a data transfer according to an alternative embodiment of the invention.

The originator's MAC sub-layer entity OMC is interfaced by one of the MAC service access units MLME-SAP, MCPS-SAP (not shown in FIG. 2). Hereinafter it will be assumed that the medium-access-control link-management entity service access point MLME-SAP will be used in this embodiment without limiting the generality of the invention.

The procedure starts by sending a known MCPS-DATA.request message which is sent by an upper layer, here an originator upper layer entity OUL to a originator's MAC sub-layer entity OMC, where the message is a primitive allowing the originator to request a data transfer to the recipient. The MLME-MCPS-DATA.request message is described in chapter 6.2.1 of the draft standard.

On receipt of the MCPS-DATA.request primitive by the originator's MAC sub-layer entity OMC, the originator's MAC sub-layer entity OMC sends a message captioned [symbol] data frame [symbol] to the MAC sub-layer entity RMC of the recipient, as shown in FIG. 2. The data frame message readily includes the payload of data that has to be sent to the recipient.

The successful reception of the data frame is communicated by the recipient's MAC sub-layer entity RMC to the originator's MAC sub-layer entity OMC by sending a message captioned [symbol] acknowledgement (requested) [symbol] . In parallel, the recipient's MAC sub-layer entity RMC issues a message captioned [symbol] MCPS-DATA.indicatiom [symbol] to its upper layer entity RUL.

The device that sends the data frame shall wait a time captioned [symbol] macAckWaitDuratiom [symbol] for a corresponding acknowledgment frame to be received. After reception of a message captioned [symbol] acknowledgement (requested) [symbol] at the MAC sub-layer entity OMC of the originator within the time period captioned [symbol] macAckWaitDuration [symbol] a message captioned [symbol] MCPS-DATA.confirm [symbol] according to chapter 6.2.2 of the draft standard is sent to the originator's upper layer entity OUL to inform the upper layer of the initiating originator whether the data transfer was successfully completed or not. It is assumed that the data transfer was successfully completed for the first data frame and that the successful completion is to be indicated by a visible color B, such as green.

In order to notify this successful data transfer, a primitive for requesting a transmission of at least one visibility frame is transmitted according to a preferred embodiment of the invention. Specifically, a request message MLME-CF.send (color B), which is sent by originator's upper layer entity OUL to the originator's MAC sub-layer entity OMC, where the message MLME-CF.send (color B) requests a transmission of at least one visibility frame having a color [symbol] B [symbol] .

After reception of the message MLME-CF.send (color B) by the originator's MAC sub-layer entity OMC, the originator's MAC sub-layer entity OMC sends a corresponding frame captioned [symbol] CVD frame (using color B) [symbol] to the MAC sub-layer entity RMC of the recipient.

In the lower half of FIG. 2, a similar message exchange is depicted with the difference that the acknowledgment is not arriving within the time period [symbol] macAckWaitDuration [symbol] and a number of retries captioned [symbol] x macMaxFrameRetries [symbol] was not able to alter this situation. It is finally assumed that the data transfer was not successfully completed for this data frame and that the transfer is to be indicated by a visible color C, such as red.

In order to notify this data transfer failure, the primitive for requesting a transmission of at least one visibility frame is transmitted according to a preferred embodiment of the invention. Specifically, a request message MLME-CF.send (color C), which is sent by originator's upper layer entity OUL to the originator's MAC sub-layer entity OMC, where the message MLME-CF.send (color C) requests a transmission of at least one visibility frame having a color [symbol] C [symbol] .

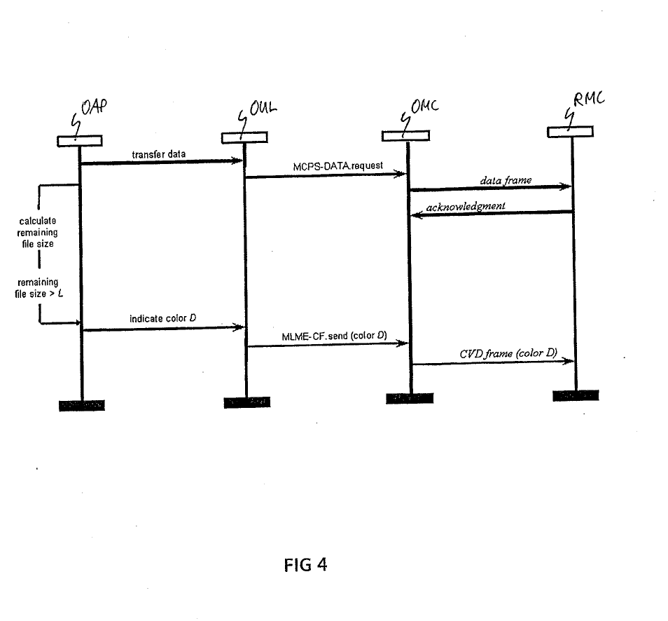

FIG. 4 depicts a timing diagram showing the exchange of messages between different layers of a recipient and an originator in a visible-light communication system, where the messages support an indication of a file-transfer status according to an alternative embodiment of the invention.

Specifically, an exchange of messages between an application layer entity OAP of an originator, an upper layer entity OUL of the originator, a MAC sub-layer entity OMC of the originator and a MAC sub-layer entity RMC of a recipient is depicted.

For the sake of clarity, the application layer entity OAP is described separately from the upper layer entity OUL of the originator. However, the application layer entity OAP is also considered part of the upper layer entity OUL.

According to FIG. 4, the application layer entity OAP of the originator sends a message captioned [symbol] transfer data [symbol] to the upper layer entity OUL of the originator. The message captioned [symbol] transfer data [symbol] includes the payload of data that has to be sent to the recipient.

The upper layer entity OUL substantially conducts the transmission by sending a known MCPS-DATA.request message to the originator's MAC sub-layer entity OMC.

On receipt of the MCPS-DATA.request primitive by the originator's MAC sub-layer entity OMC, the originator's MAC sub-layer entity OMC sends a message captioned [symbol] data frame [symbol] to the MAC sub-layer entity RMC of the recipient. The data frame message accordingly includes the payload of data which has to be sent to the recipient.

The successful reception of the data frame is communicated by the recipient's MAC sub-layer entity RMC to the originator's MAC sub-layer entity OMC by sending a message captioned [symbol] acknowledgement [symbol] .

For the sake of clarity, other confirmation and/or acknowledgment messages, e.g., sent to the upper layer entity OUL of the originator, to the application layer entity OAP of the originator are not shown in FIG. 4. Also not shown are messages exchanged by recipient's MAC sub-layer entity RMC to its upper layers.

The application layer entity OAP of the originator calculates the remaining file size while the data transfer is in progress. As long as the remaining file size exceeds a value of L bytes, see FIG. 4, a visual notification remains unchanged. At the time the remaining file size no longer exceeds a value of L bytes, a message MLME-CF.send (color D) is used to effect a visual notification that the data transfer has been almost completed. This may be exemplarily indicated by a assigning a yellow color for color D.

In fact, the application is the most suitable entity for calculating the remaining file size. The major drawback of the prior art, outlined in the description of FIG. 7, whereby on the level of the MAC sub-layer such calculations are hardly feasible, is hereby rectified using the inventive principle of placing the discretion of requesting a notification in the upper layers, here, in the application level.

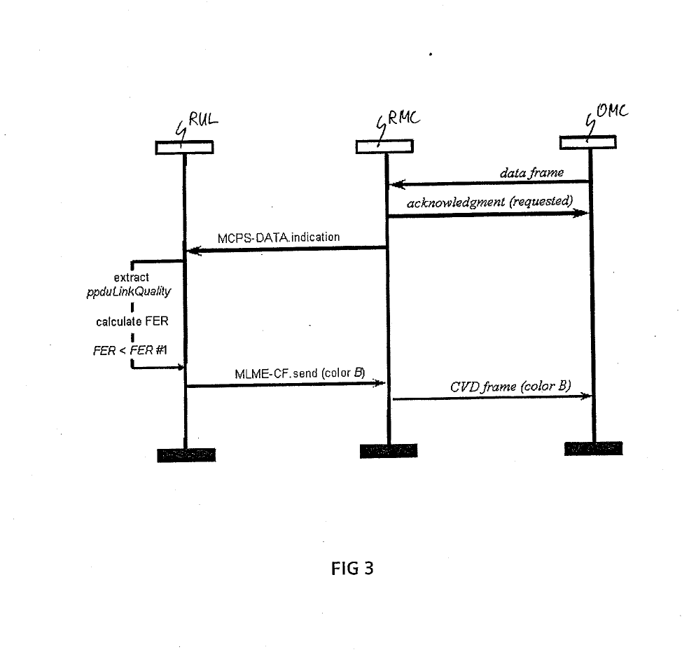

FIG. 3 depicts a timing diagram showing the exchange of messages between different layers of a recipient and an originator in a visible-light communication system, where the messages support a channel-quality indication according to an alternative embodiment of the invention.

Specifically, an exchange of messages between an upper layer entity RUL of a recipient, a MAC sub-layer entity RMC of the recipient and a MAC sub-layer entity OMC of an originator is depicted.

It is assumed that the originator's MAC sub-layer entity OMC sends a message captioned [symbol] data frame [symbol] to the MAC sub-layer entity RMC of the recipient. The data frame message readily includes payload of data which has to be sent to the recipient.

The successful reception of the data frame is communicated by the recipient's MAC sub-layer entity RMC to the originator's MAC sub-layer entity OMC by sending a message captioned [symbol] acknowledgement (requested) [symbol] . In parallel, the recipient's MAC sub-layer entity RMC issues a message captioned [symbol] MCPS-DATA.indication [symbol] to its upper layer entity RUL.

In the upper layer entity RUL, the communication quality is calculated. The communication quality may be obtained by various metrics. For example, FER or frame error rate statistics can be averaged over multiple frames to choose the color of the CVD frame.

For example, a parameter [symbol] ppduLinkQuality [symbol] according to chapter of 9.3.3 of the draft standard can be used for this purpose. Based on this parameter, a frame error rate or FER is calculated. It, according to FIG. 3, is lower than a threshold of FER #1, a request message MLME-CF.send (color B) is sent by the recipient's upper layer entity RUL to the recipient's MAC sub-layer entity RMC, the message MLME-CF.send (color B) requesting a transmission of at least one visibility frame; having a color [symbol] B [symbol] .

The visual notification can help provides a misalignment indication to the user in a line-of-sight link. Different colors can be used to indicate different states of misalignment. For example, green, blue, and red CVD frames can be used to visualize high, middle and low data rates respectively. The choice of the colors and the data rate range is, again, left to the implementer.

A major advantage of the proposed notification according to the invention is that a blinking notification, which is specified in a separate chapter of the draft standard, can readily be facilitated by the invention.

If color of CVD frames is chosen differently from that of data transmission, MLME-CF.send can be used for blinking by setting CVDRepetitions, CVDDuration, and CVDCycleLength accordingly. Even multi-color blinking is feasible by the invention. One can even achieve same color blinking by adjusting the duty cycle.

In order to accommodate 1 Hz blinking, the CVDCycleLength must be set to (100) and for 2 Hz blinking set CVDCycleLength to (200).

If a 50% duty cycle is chosen for the blinking, the corresponding lengths of the CVD frames are CVDDuration=(50) and (100), respectively.

Furthermore, dimming and MLME-CF.send can be used in combination. If, e.g., transmitter is currently set at 90% dimming, the dimming primitive can be used to increase radiant power of transmitter during emission of CVD frames.

This would be implemented as follows:
Change dimmer setting with MLME-SET primitive (set the MAC-PIB attribute macDim to the intended level);
Invoke submission of one CVD frame with MLME-CF.send (CVDRepetitions=1; it is advantageous to set CVDCycleLength=CVDDuration).
After completion of the CVD transmission, as indicated, for instance by MLME-CF.confirm, reset the dimming level to the initial level by use of the MLME-SET primitive (see above).
After a preset duration, such as macCVDCycleLength, start this process.

According to FIG. 5, not only access to the MAC sub-layer through next higher layers but also device-management entity DME is possible, which itself has access to the MLME interface (MLME-SAP). Thus, not only higher/upper-layer applications can invoke color-function and blinking-notification support from standard-conform VLC devices.

The invention opens standard-conform VLC devices up to novel applications:
A facility-management system of a building is interfacing to VLC-enabled lamps via the DME interface. In cases of alerts, the MLME-CF interface is used to make all the lamps blink, such as with red repetitive color bursts. This can automatically be adapted to the lamp color. If a lamp usually emits [symbol] reddish [symbol] light, it chooses a different color for the alert, for instance blue.
The facility-management system uses this functionality to both warn and guide people during an emergency. For instance, it invokes the lamps illuminating escape routes with a different color or a different repetition frequency or duty cycle.
The facility-management of a multiple-user building, such as a library, informs the visitors of the impending closure of the building at the end of the day via repetitious changes of the color and/or intensity of the emitted light.
Another option is to address the lamps through a remote lamp-control system, such as Digital Addressable Lighting Interface DALI.
The facility-management system (which includes the lamps) of a private home is coupled to the TIVO, set-top box, or the like. When an important event occurs, such as the second half of a football game starts, it changes the color of the emitted light to alert the household of this fact. Here, the set-top box forwards an alert to the facility-management system, which in turn invokes color-function support of all lamps via the DME interface. In a similar scenario, the household is informed of the end of a commercial break by aid of color-function support.
A battery-driven VLC emitter informs human users of a low battery by invoking the color-function support. This can also be done in combination with the dimming functionality using a blinking notification.
A computer that is connected to the DME of a lamp via, for instance, power-line communication, uses color-function support, optionally in combination with the dimming functionality, to inform the user that an email has arrived.
[symbol] Down stream [symbol] from a traffic accident, the color and/or intensity of the light emitted by street lamps is changed by aid of color-function support and/or the dimming functionality. Here, the color and/or frequency of this change are adapted to the position of the street lamp. For instance, lamps that are closer to the accident are invoked with shorter CVD cycle lengths than those further away.
All lamps controlled by a municipality are color and/or intensity modulated with a known pattern when a major catastrophe is occurring and the people in the municipality are asked to consult the public information services in order to inform themselves about the catastrophe and recommended actions.

The disclosed embodiments of the invention are directed to providing a unified solution with the following directives:
Only uses one set of MAC-PIB parameters for all embodiments;
Defines a unified, slim interface between upper layers and the device-management entity (DME) that also allows changing the above MAC-PIB parameters;
Enables non-application-layer specific use cases via the device-management entity (DME);
Support a straight-forward implementation of the blinking-notification functionality.

Disclosed embodiments of the invention provide the following advantages:
Minimal implementation overhead in the MAC can be accessed by higher communication layers and also the device-management entity (DME); and
Fits within a large number of use cases and applications.

Embodiments of the invention can be implemented in computing hardware (computing apparatus) and/or software, including but not limited to any computer that can store, retrieve, process and/or output data and/or communicate with other computers.

The processes can also be distributed via, for example, downloading over a network such as the Internet. A program/software implementing the embodiments may be recorded on computer-readable media comprising computer-readable recording media. The program/software implementing the embodiments may also be transmitted over a transmission communication media such as a carrier wave. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

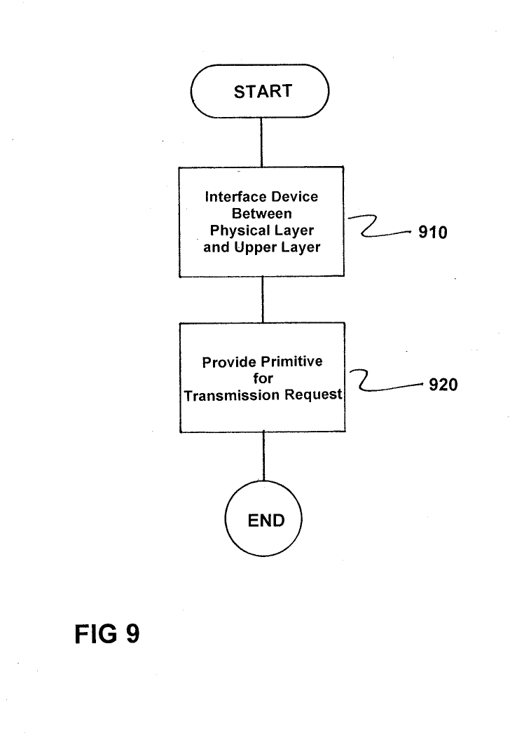

FIG. 9 is a flowchart of a method for providing visible notification by a device in a system for visible-light communication, where the device includes a medium-access-control entity (MAC). The method comprises interfacing the device between a physical layer (PHY) and at least one upper layer, the at least one upper layer being hierarchically arranged above the medium-access-control entity (MAC), as indicated in step 910. In accordance with the invention, the medium-access-control entity (MAC) includes at least one interface (MLME-SAP, MCPS-SAP) to said at least one upper layer. Next, a primitive for requesting, is provided by the at least one upper layer to the at least one interface (MLME-SAP, MCPS-SAP) of the medium-access-control entity (MAC), a transmission of at least one visibility frame, as indicated in step 920.

The invention has been described in detail with particular reference to preferred embodiments thereof and examples, but it will be understood that variations and modifications can be effected within the spirit and scope of the invention covered by the claims.

While there have been shown, described, pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested farm or embodiment as a general matter of design choice. It is the intention, therefore, to be limited only as indicated by the scope of the claims appended hereto.

1.-10. (canceled)

11. A method for providing visible notification by a device in a system for visible-light communication, the device including a medium-access-control entity (MAC), the method comprising:
interfacing the device between a physical layer (PHY) and at least one upper layer, the at least one upper layer being hierarchically arranged above the medium-access-control entity (MAC), the medium-access-control entity (MAC) including at least one interface (MLME-SAP, MCPS-SAP) to said at least one upper layer; and
providing a primitive for requesting, by the at least one upper layer to the at least one interface (MLME-SAP, MCPS-SAP) of the medium-access-control entity (MAC), a transmission of at least one visibility frame.

12. The method according to claim 11, further comprising:
providing a primitive for confirming, by the at least one interface (MLME-SAP, MCPS-SAP) of the medium-access-control entity (MAC) to the at least one upper layer, a transmission of the at least one visibility frame.

13. The method according to claim 11, wherein primitive for requesting comprises at least one of:
(i) a parameter defining a number of times a color visibility dimming (CVD) frame is repeatedly sent,
(ii) a parameter defining a color of the CVD frame during a pertinent repetition,
(iii) a parameter defining a duration of the CVD frame, and
(iv) a parameter defining a time between a beginning of a transmission of two adjacent CVD frames during the pertinent repetition.

14. The method according to claim 11, wherein said primitive is used to request a blinking notification.

15. The method according to claim 11, wherein the system for visible-light communication is based on Institute of Electrical and Electronic Engineers (IEEE) standard 802.15.7.

16. A device for providing visible notification in a system for visible-light communication, the device comprising:
a medium-access-control entity (MAC) interfacing in between a physical layer (PHY) and at least one upper layer, the at least one upper layer being hierarchically arranged above the medium-access-control entity (MAC);
wherein the medium-access-control entity (MAC) including at least one interface (MLME-SAP, MCPS-SAP) to the upper layer; and
wherein the at least one upper layer entity provides a primitive for requesting a transmission of at least one visibility frame by at least one interface (MLME-SAP, MCPS-SAP) of the medium-access-control entity (MAC).

17. The device according to claim 16, wherein the at least one interface (MLME-SAP, MCPS-SAP) of the medium-access-control entity (MAC) provides a primitive for confirming a transmission of at least one visibility frame to the at least one upper layer.

18. The device according to claim 15, wherein the upper layer includes at least one of a device-management entity (DME), a logical link control layer (LLC) and a service-specific convergence sub-layer (SSCS).

19. The device according to claim 17, wherein the upper layer includes at least one of a device-management entity (DME), a logical link control layer (LLC) and a service-specific convergence sub-layer (SSCS).

20. The device according to claim 16, wherein the primitive for requesting comprises at least one of:
(i) a parameter defining a number of times a CVD frame is repeatedly sent,
(ii) a parameter defining a color of the CVD frame during a pertinent repetition,
(iii) a parameter defining a duration of the CVD frame, and
(iv) a parameter defining a time between a beginning of a transmission of two adjacent CVD frames during the pertinent repetition.

21. The device according to claim 17, wherein the primitive for requesting comprises at least one of:
(i) a parameter defining a number of times a CVD frame is repeatedly sent,
(ii) a parameter defining a color of the CVD frame during a pertinent repetition,
(iii) a parameter defining a duration of the CVD frame, and
(iv) a parameter defining a time between a beginning of a transmission of two adjacent CVD frames during the pertinent repetition.

22. The device according to claim 18, wherein the primitive for requesting comprises at least one of:
(i) a parameter defining a number of times a CVD frame is repeatedly sent,
(ii) a parameter defining a color of the CVD frame during a pertinent repetition,
(iii) a parameter defining a duration of the CVD frame, and
(iv) a parameter defining a time between a beginning of a transmission of two adjacent CVD frames during the pertinent repetition.

23. The device according to claim 16, wherein the system for visible-light communication is based on Institute of Electrical and Electronic Engineers (IEEE) standard 802.15.7.

24. A non-transitory computer program product encoded with a computer program that causes visible notification by a device in a system for visible-light communication, the device including a medium-access-control entity (MAC), the computer program comprising:
program code for interfacing the device between a physical layer (PHY) and at least one upper layer, the at least one upper layer being hierarchically arranged above the medium-access-control entity (MAC), the medium-access-control entity (MAC) including at least one interface (MLME-SAP, MCPS-SAP) to said at least one upper layer; and
program code for providing a primitive for requesting, by the at least one upper layer to the at least one interface (MLME-SAP, MCPS-SAP) of the medium-access-control entity (MAC), a transmission of at least one visibility frame.
